(19) United States
(12) Patent Application Publication
(10) Pub. No.: US 2008/0168096 A1
(43) Pub. Date: Jul. 10, 2008

(54) EXTRACTING BUSINESS LOGIC FROM THE USER INTERFACE OF SERVICE AND PRODUCT ORIENTED COMPUTERIZED SYSTEMS

(76) Inventors: Shalom DASKAL, Ramat Efal (IL); Avraham Kochva, Kfar Haroe (IL); Ronen Yochpaz, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/947,130

(22) Filed: Nov. 29, 2007

Related U.S. Application Data
(60) Provisional application No. 60/879,389, filed on Jan. 8, 2007.

(51) Int. Cl. G06F 17/30

(52) U.S. Cl. 707/104.1; 707/E17.044

(57) ABSTRACT

A system and method for extracting the business architecture and related logic of an organization according to the user interface of the organization's computerized systems. This is performed using the following process: The User Interface logic is mapped thoroughly using a crawler. The output of this process may be in the form of a business architecture tree. In addition, a filtering algorithm is used to filter out the portions of the mapped interface that are not relevant to the business logic as well as redundancies. The filtering algorithm is implemented using a dictionary, supplying the algorithm with early knowledge about the terminology which should be excluded from the Business logic. Moreover, the dictionary may be used to include more nodes to the tree representation of the business logic.

### CROSS-REFERENCE TO RELATED APPLICATIONS

This application claims the benefit of U.S. Provisional Patent Application 60/879,389, filed Jan. 8, 2007, which is incorporated herein by reference in its entirety.

### FIELD OF THE INVENTION

The present invention relates generally to service and product oriented businesses, and more particularly, to computerized systems of such businesses.

### BACKGROUND OF THE INVENTION

Service Oriented Architecture (SOA) is an emerging concept where software applications are built up out of software services. Services are defined as relatively large, intrinsically unassociated units of functionality, which have no calls to each other embedded in them.

Service and product oriented businesses are companies and organizations whose primary function is to perform labor tasks for customers. These businesses may include financial organizations (e.g., banks, insurance companies), telecommunication companies, energy companies, transportation companies, utilities companies, healthcare companies as well as non-for-profit organizations such as governmental agencies.

Service and product oriented businesses are characterized in specific business architecture and related business rules (aka “business logic”) that govern the entire business activity (for instance a bank business architecture and related business rules will consist of: Debit, Credit, Loans, Investments and Saving services). Presently, the business architecture and related rules are at the base of the computerized systems that serve both the employees and the customers of these businesses. The computerized systems comprise software applications that manage a very large amount of data by applying much functionality thereon, while adhering to the predefined business logic. These software applications are often the result of an extensive software development process that is constantly being modified and improved.

One of the challenges of the software development and maintenance process of these large software applications is managing the applications in evolving business architecture and ever changing business rules environment. New rules or existing rule updates in one part of the computerized system may not be seen elsewhere. Often the same rule may be implemented in many places, deep in application code.

One area where SOA has been gaining ground is in its power as an architecture and mechanism for defining business services and operating models, and thus provides a structure for IT to deliver against the actual business requirements and adapt in a similar way to the business. The purpose of using Service Oriented Architecture for business mapping is to ensure that the services created properly represent the business view and are not just what technologists think the business services should be. At the heart of SOA planning is the process of defining architecture for the use of information in support of the business, and the plan for implementing such architecture.

### SUMMARY OF THE INVENTION

The present invention takes a unique approach for extracting the business logic of an organization from the user interface of the organization's computerized systems. This is performed using the following process: The User Interface logic is mapped thoroughly using mapping software such as a crawler or debugger tool or testing tool or tracing tool. The output of this process may be in the form of a tree representation or graph representation of the user interface. In addition, a filtering algorithm is used to filter out the portions of the mapped interface that are not relevant to the business logic as well as redundancies. The filtering algorithm is implemented using a dictionary, supplying the algorithm with early knowledge and continuous learning capability about the terminology which should be excluded from the business logic. Moreover, the dictionary may be used to include more nodes to the representation of the business logic.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 shows a flowchart depicting the steps of the method according to some embodiments of the present invention;

FIG. 2 shows a schematic block diagram depicting the elements of the system according to some embodiments of the present invention;

FIG. 3 shows an exemplary user interface page of a financial organization; and

FIG. 4 shows an exemplary business logic extraction from the user interface of FIG. 3 of the present invention.

The drawings together with the description make apparent to those skilled in the art how the invention may be embodied in practice.

Further, where considered appropriate, reference numerals may be repeated among the figures to indicate corresponding or analogous elements.

### DETAILED DESCRIPTION OF THE INVENTION

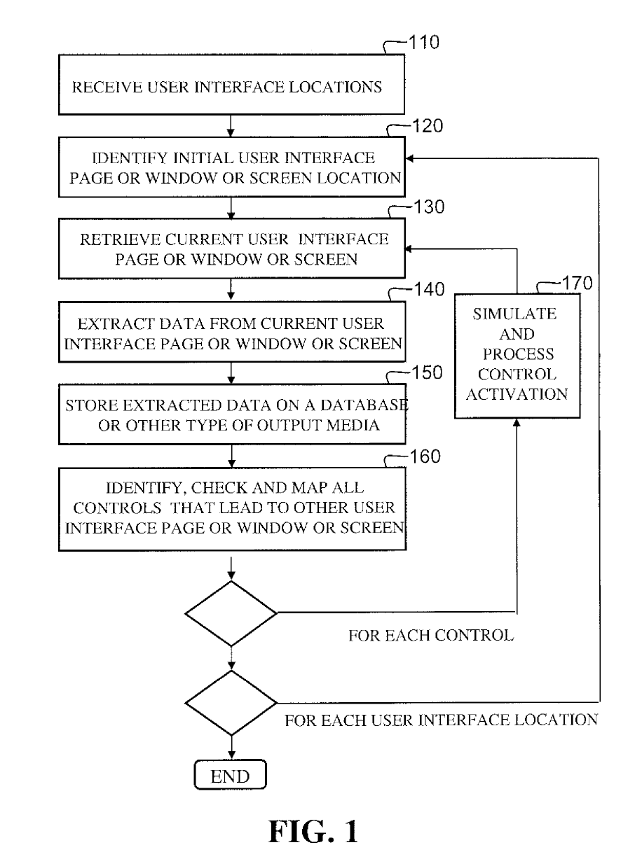

FIG. 1 shows a flowchart depicting the steps of the method according to some embodiments of the present invention. The flowchart depicts steps that may be taken in order to extract the business logic scheme of a service/product oriented organization, wherein said business logic is extracted via the user interface of the computerized system of said service and/or product oriented business. On step 110, the user interface locations are received. Naturally, for each type of user interface a different locator exist. For example, in the case that the user interface is a website, a URL will suffice, for Swing based User Interface, the main class and the jar file are required and for native windows user interface, the executable (.exe) of the program is required. On step 120 the initial user interface is identified. This is the start menu of each user interface, where either the customer or the employee starts their interaction with the computerized system of the organization. Then, on step 130, the current user interface module such as page window or screen is retrieved for each and every page or window or screen of the user interface. This is followed by step 140 in which data are extracted from each said pave or window or screen. The data is filtered and then stored as business logic on a database or other type of output media, as depicted in step 150, and all the controls on each page or window or screen are identified 160. Then each and every control (such as link, button, widget, clicked character or any type of clickable control) is checked, identified and mapped, business logic is simulated and processed 170.

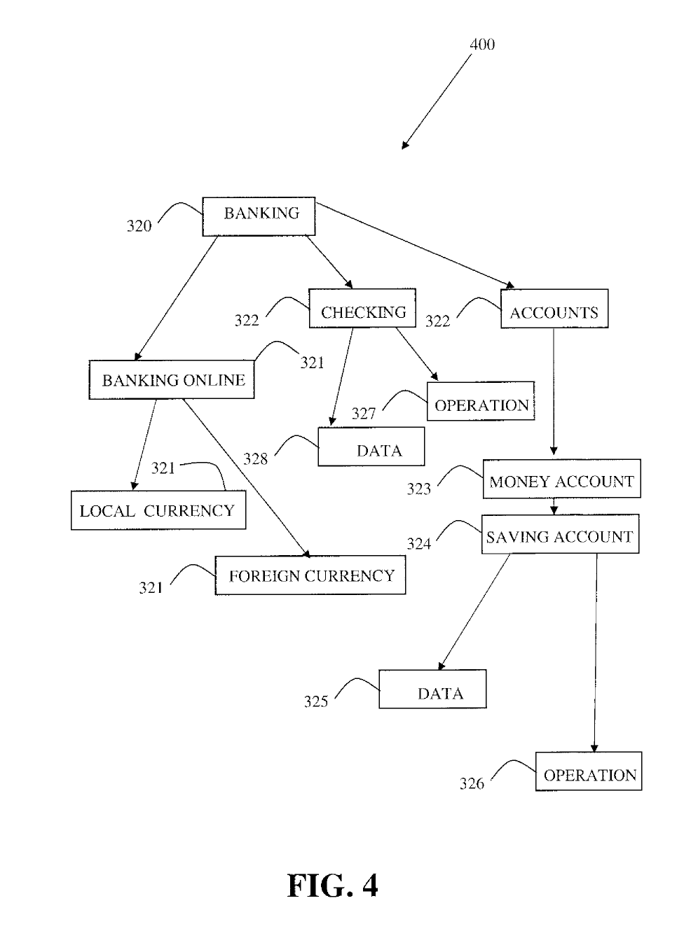

According to some embodiments of the invention, the checking may be performed using a dictionary that allows the method to clearly define the region of interest of the business logic in view of terminology, hierarchy and interplay between the different components of the user interface logic scheme. This enables the subtraction and addition of portion of logic to and from the user interface logic scheme. After reviewing and checking the entire user interface and exhausting all UI components (page, window, screen etc.), the result is the business logic scheme of the organization (FIG. 4).

According to some embodiments of the invention, the business logic scheme comprises a tree diagram comprising all the hierarchy of the organization functionalities and their characteristics.

According to some embodiments of the invention, the method comprises the steps of: mapping the user interface logic reflected by the user interface of a computerized system and filtered by using a dictionary, extracting the business logic scheme from the mapped user interface logic scheme.

According to some embodiments of the invention, the aforementioned step of mapping the user interface logic of a user interface of a computerized system is preceded by receiving at least one user interface location; identifying initial user interface page or window of screen location and extracting data from each and every user interface page or window or screen.

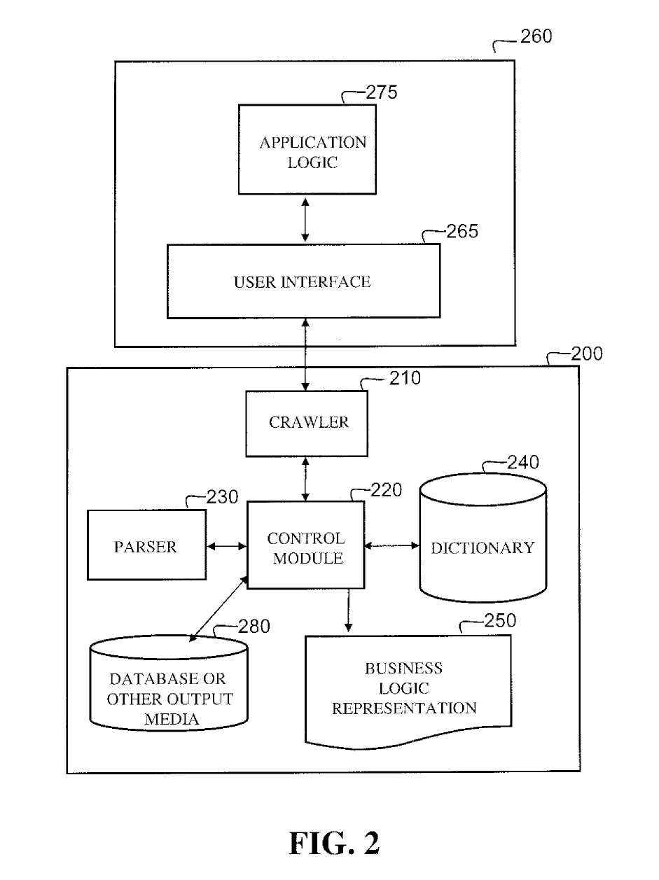

FIG. 2 shows a schematic block diagram depicting the elements of the system according to some embodiments of the present invention. FIG. 2 shows a system for extracting the business logic of a service/product oriented organization 200, wherein said business logic is extracted via the user interface of the computerized system 260 of said service/product oriented organization. The system for extracting the business logic comprises a control module 220 that is operatively connected to a crawler 210, a parser 230, and a dictionary 240, a database or other output media 280 keeping all the business logic of the organization. The crawler 210 is configured to connect to the computerized system 260 of said service/product oriented organization in accordance to the control nodule operation. The computerized system 260 usually is comprised of a user interface 265, application logic 275 which are the different software applications (set of software components or SOA services) presenting the business products and services offered by the organization. The parser 230 is configured to parse each and every page or window or screen of the user interface presented to it by the control module. The control module 220 is configured to map the user interface logic thereby utilizing the dictionary to extract the business logic scheme of the said service/product oriented organization from the mapped logic of the said user interface.

According to some embodiments of the invention, the service/product oriented organization may be any of the following: a financial organization (e.g., banks, insurance companies), telecommunication companies, energy companies, transportation companies, utilities companies, computer companies, software companies, retail companies, healthcare companies as well as non-for-profit organizations such as governmental agencies

According to some embodiments of the invention the users interface is at least one of the following: a Web based user interface, a Web 2.0 based user interface, a semantic Web based user interface, a Graphical user interfaces (GUI), a Command line user interface, a Tactile user interface, a touch user interface, a attentive user interfaces, a batch user interface, a conversational Interface Agent, a crossing-based user interface, a gesture user interface, a intelligent user interface, a live user interfaces (LUI), a multi-screen user interfaces, a non-command user interface, a reflexive user interface, a tangible user interface, a text user interface, a voice user interface, a zero-input interface, a zooming user interface, a recorded script of user interface, a recorded test scenario of a user interface, a Swing based user interface, a hyperlinked document, a networked graphical user interface, a 3270 based user interface, a VT100 based user interface, a VT200 based user interface, a VT300 based user interface, a VT400 based user interface, a widgets based user interface, a menu driven based user interface, a window based user interface, a MS-windows based user interface, a Mac-Os user interface, a Linux Os user interface, a Unix based user interface.

According to some embodiments of the invention the mapping of the interface by the control module is performed by extracting the control in each interface module such as page, window or screen and simulating thereof.

According to some embodiments of the invention the control module 220 further comprises an implementation of a filtering algorithm applied on the napped user interface logic and filters out information such as: interface logic portion not relevant to the business logic, redundancies of the user interface logic portions, pictures, embedded graphics, advertisements, banners, flash components, messages, headers, footers, text, hidden text, control characters, notes, remarks, pop-ups, audio, encrypted data, blockups, colors, navigation controls, navigation text, help, login, tutorial, metadata.

According to some embodiments of the invention the control module 220 is further configured to add portions to the business logic scheme, in accordance with the dictionary in view of the mapped user interface logic.

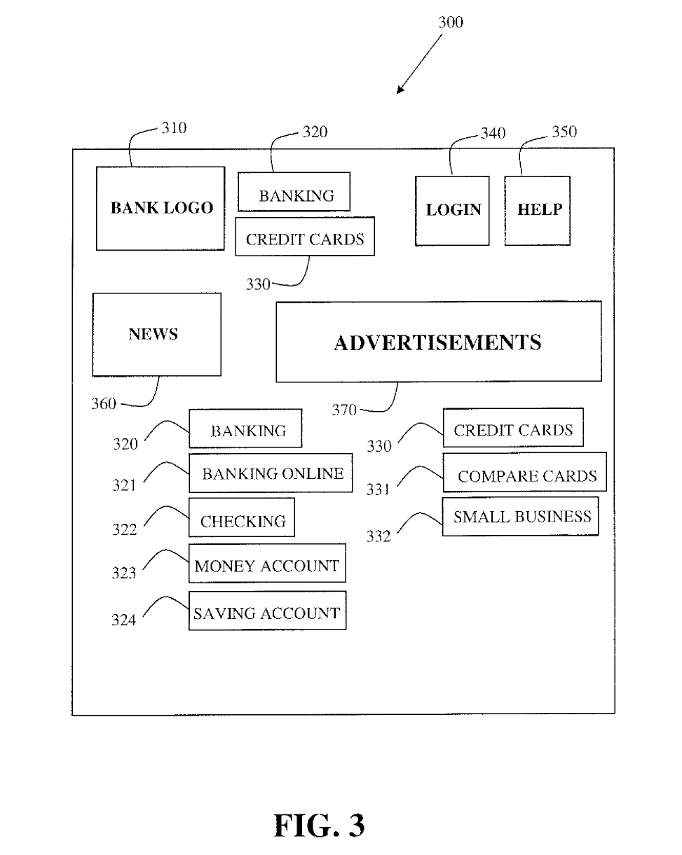

FIG. 3 shows a representative webpage of a financial institution such as a commercial bank. The webpage involves informative as well as operative modules. The present invention is directed at filtering out the informative modules thus extracting the operative modules representing the entire pool of services and products offered by the bank. The webpage serves as the portal of all the virtual services and products provided and offered by the bank to the account holders. Naturally, the webpage contains widgets, icons and controls that are non related components to the virtual services and products of the bank. Some components are related to the operation of the webpage such as: web logic controls, advertisements, informative controls and the like.

Specifically, the webpage 300 comprises of service parents such as banking 320 and credit cards 330. Other service parents may be loans, credit lines, investments etc. Each service parent expands to sub services such as banking online 321, checking 322, money account 323, saving account 324, compare credit cards 331, and credit cards for small businesses 332. Apart from these operative controls and sub classes leading to virtual banking services and products, there are non-business related controls and data. These are the advertisements 370 common on such websites, the Help icon 350, the Login control 340, the bank logo 310, news flashes 360 and the like. All these non-business related controls and data are filtered out by the crawler using the dictionary.

FIG. 4 shows the output of the crawler according to the present invention. After activating all the controls and filtering out the non-business related controls and data, a tree representing of the business logic is provided. Shown here only a segment of the whole tree—the banking parent is drilled down to show the sub services and products of the hierarchy to include (but not limited to) banking online, checking and accounts on one level, online banking drilled down to include foreign and local currency; checking and accounts drilled down to include both information and operation as well as other sub services and products. Similarly, other parent services such as loans and investments are thus represented as a tree with a hierarchical order. Redundancies and non-business related data is omitted.

According to some embodiments of the invention, the system can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system for extracting the business logic of a service and product oriented organization, wherein said business logic is extracted via the user interface of the computerized system of said service and product oriented organization, said system for extracting the business logic comprising:
a control module; operatively connected to the following modules:
a crawler;
a parser;
a database or other output media; and
a dictionary;
wherein said crawler is configured to connect to the computerized system of said service or product oriented organization in accordance to the control module operation;
and wherein the parser is configures to parse each and every module of the user interface presented to it by the control module;
and wherein the control module is configured to map the user interface logic thereby utilizing the dictionary to extract the business logic data of the said service or product oriented organization from the mapped logic of the said user interface and wherein the control module is configured to store the business logic in a database or other output media.

2. The system of claim 1, wherein the dictionary comprises an exclusion list.

3. The system of claim 1, wherein the service and product oriented organization is at least one of the following: a financial organization, a technology company, a consumer company, a materials company, a services company, a conglomerate, a capital goods company, a bank, an insurance company, a telecommunication company, an energy company, a utilities company, a healthcare company, a transportation company, a governmental agency, a retail company, a computer company, a software company, a non-for-profit organization.

4. The system of claim 1, wherein the users interface is at least one of the following: a Web based user interface, a Web 2.0 based user interface, a semantic Web based user interface, a Graphical user interfaces (GUI), a Command line user interface, a Tactile user interface, a touch user interface, a attentive user interfaces, a batch user interface, a conversational Interface Agent, a crossing-based user interface, a gesture user interface, a intelligent user interface, a live user interfaces (LUI), a multi-screen user interfaces, a non-command user interface, a reflexive user interface, a tangible user interface, a text user interface, a voice user interface, a zero-input interface, a zooming user interface, a recorded script of user interface, a recorded test scenario of a user interface, a Swing based user interface, a hyperlinked document, a networked graphical user interface, a 3270 based user interface, a VT100 based user interface, a VT200 based user interface, a VT300 based user interface, a VT400 based user interface, a widgets based user interface, a menu driven based user interface, a window based user interface, a MS-windows based user interface, a Mac-Os user interface, a Linux Os user interface, a Unix based user interface.

5. The system of claim 1, wherein the mapping of the interface by the control module is performed by extracting the control in each interface module and simulating thereof.

6. The system of claim 1, wherein the control module further comprises an implementation of a filtering algorithm applied on the mapped user interface logic and filters out at least one of the following: interface logic portion not relevant to the business logic, redundancies of the user interface logic portions, pictures, embedded graphics, advertisements, banners, flash components, messages, headers, footers, hidden text, control characters, notes, remarks, pop-ups, audio, encrypted data, blockups, colors, navigation controls, text, navigation text, help, login, tutorial, metadata, icons, logo.

7. The system of claim 1, wherein the control module is further configured to add portions to the business logic scheme, in accordance with a dictionary in view of the mapped user interface logic.

8. A method for extracting the business logic of a service and product oriented organization, wherein said business logic is extracted via the user interface of the computerized system of said service and product oriented business, said method comprising the steps of:
mapping the user interface logic of a user interface of a computerized system;
using a dictionary, extracting the business logic scheme from the mapped user interface logic scheme.

9. The method of claim 8, wherein mapping the user interface logic of a user interface of a computerized system is preceded by:
receiving at least one user interface location;
identifying initial user interface module location;
extracting data from each and every user interface module.

10. The method of claim 9, wherein extracting data from each and every user interface page or window or screen is followed by:
storing extracted data on a database or other type of output media;
identifying all controls that lead to other user interface module.

11. The method of claim 8, wherein extracting the business logic scheme from the mapped user interface logic scheme is further performed using a learning algorithm.

12. The method of claim 8, wherein the dictionary is an industry related dictionary.

13. A computer program product for extracting the business logic of a service and product oriented organization, wherein said business logic is extracted via the user interface of the computerized system of said service and product oriented organization, said computer program product comprising:
a computer usable medium having computer usable program code tangibly embodied thereon, the computer usable program code comprising:
a computer usable program code for mapping the user interface logic of a user interface of a computerized system;
a computer usable program code for using a dictionary for extracting the business logic scheme from the mapped user interface logic data;

14. The computer program product according to claim 13, further comprising:
a computer usable program code for storing extracted data on a dedicated database or other type of output media;
a computer usable program code for identifying all controls that lead to other user interface page or window or screen.
